(19) United States
(12) Patent Application Publication
(10) Pub. No.: US 2025/0085470 A1
(43) Pub. Date: Mar. 13, 2025

(54) DISPLAY DEVICE AND LIGHT MODULE THEREOF

(71) Applicant: E Ink Holdings Inc., HSINCHU (TW)

(72) Inventors: Jen-Yuan CHI, HSINCHU (TW); Yu-Nan PAO, HSINCHU (TW); Chia Feng HO, HSINCHU (TW)

(21) Appl. No.: 18/792,576

(22) Filed: Aug. 2, 2024

(30) Foreign Application Priority Data
Sep. 7, 2023 (TW) 112134004

(51) Int. Cl. F21V 8/00; F21V 19/00; F21Y 113/13; F21Y 115/10

(52) U.S. Cl. CPC G02B 6/0068; F21V 19/0025; G02B 6/0073; G02B 6/0091; F21Y 2113/13; F21Y 2115/10

(57) ABSTRACT

A light module includes a light guide plate, a first light source and a second light source. The light guide plate has an inner light emitting surface, an outer light emitting surface opposite to the inner light emitting surface, and a light incident surface connecting the inner light emitting surface and the outer light emitting surface. The first light source is disposed on the light incident surface and located between the inner light emitting surface and the outer light emitting surface, and the first light source emits light of a first color temperature. The second light source is disposed on the light incident surface and located between the first light source and the inner light emitting surface, and the second light source emits light of a second color temperature, and the difference between the first color temperature and the second color temperature is greater than 2000K.

### RELATED APPLICATIONS

This application claims priority to Taiwan Application Serial Number 112134004, filed Sep. 7, 2023, which is herein incorporated by reference in its entirety.

### BACKGROUND

### Field of Invention

The present disclosure relates to a display device. More particularly, the present disclosure relates to a light module including light sources with different color temperatures, and a display device including the aforementioned light module.

### Description of Related Art

At present, some display devices include a light module and a display panel. The light module emits light to illuminate the display surface of the display panel to display an image. The color temperature of the light has quite an impact on images, especially color images. Hence, when the light module emits light with appropriate color temperature, it will help maintain or improve the image quality of the display device. However, the conventional way of adjusting the light color temperature of the light module is to stagger two kinds of light emitting diodes that emit light of different color temperatures on the same light bar. The pitch between the light emitting diodes of the same color temperature will be increased on the dual color temperature light bar, resulting in a larger light mixing area, which makes it more difficult to be applied to narrow-bezel products compared to the single color temperature light bar.

### SUMMARY

At least one embodiment of the disclosure provides a light module, which can help to reduce or to prevent the abovementioned defects.

Another embodiment of the disclosure provides a display device, which includes the abovementioned light module.

The light module according to at least one embodiment of the disclosure includes a light guide plate, a first light source and a second light source. The light guide plate has an inner light emitting surface, an outer light emitting surface opposite to the inner light emitting surface along a first direction, and a light incident surface connecting the inner light emitting surface and the outer light emitting surface. The first light source is disposed on the light incident surface and located between the inner light emitting surface and the outer light emitting surface along the first direction, and the first light source emits light of a first color temperature. The second light source is disposed on the light incident surface and located between the first light source and the inner light emitting surface along the first direction, and the second light source emits light of a second color temperature. A difference between the first color temperature and the second color temperature is greater than 2000K.

The display device according to at least one embodiment of the disclosure includes a display panel having a display surface and a light module, where the light module disposed on the display surface and includes a light guide plate, a first light source and a second light source. The light guide plate has an inner light emitting surface, an outer light emitting surface and a light incident surface, where the inner light emitting surface faces the display surface and is opposite to the outer light emitting surface along a first direction, and the light incident surface connects the inner light emitting surface and the outer light emitting surface. The first light source is disposed on the light incident surface and located between the inner light emitting surface and the outer light emitting surface along the first direction, and the first light source emits light of a first color temperature. The second light source is disposed on the light incident surface and located between the first light source and the inner light emitting surface along the first direction, and the second light source emits light of a second color temperature. A difference between the first color temperature and the second color temperature is greater than 2000K.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic cross-sectional view of a reflective display device according to at least one embodiment of the disclosure.

FIG. 2 is a schematic cross-sectional view of a light module according to at least one embodiment of the disclosure.

FIG. 3 is a schematic view of a light source according to at least one embodiment of the disclosure.

FIG. 4 is a schematic top view of a reflective display device according to at least one embodiment of the disclosure.

### DETAILED DESCRIPTION

The embodiments of the present disclosure are discussed in detail below. It will be appreciated, however, that the embodiments provide many applicable concepts which may be implemented in a wide variety of specific contexts. The discussed and disclosed embodiments are for illustrative purposes only and are not intended to limit the scope of patent applications in this case.

In the following description, in order to clearly present the technical features of the present disclosure, the dimensions of elements in the drawings will be enlarged in unequal proportions. Therefore, the description and explanation of the following embodiments are not limited to the sizes and shapes presented by the elements in the drawings, but should cover the sizes, shapes, and deviations of the two due to actual manufacturing processes and/or tolerances. For example, the flat surface shown in the drawings may have rough and/or non-linear characteristics, and the acute angle shown in the drawings may be round. Therefore, the elements presented in the drawings in this case are mainly for illustration, and are not intended to accurately depict the actual shape of the elements, nor are they intended to limit the scope of patent applications in this case.

The spatial relative terms used in the present disclosure, such as “below,” “under,” “above,” “on,” and the like, are intended to facilitate the recitation of a relative relationship between one element or feature and another as depicted in the figures. The true meaning of these spatial relative terms includes other orientations. For example, the relationship between one element and another may change from “below” and “under” to “above” and “on” when the figure is turned 180 degrees up or down. In addition, spatially relative descriptions used in the present disclosure should be interpreted in the same manner.

It should be understood that while the present disclosure may use terms such as “first”, “second”, “third”, etc. to describe various elements or features, these elements or features should not be limited by these terms. These terms are primarily used to distinguish one element from another, or one feature from another. In addition, the term “or” as used in the present disclosure may include, as appropriate, any one or a combination of the listed items in association.

Moreover, the present disclosure may be implemented or applied in various other specific embodiments, and the details of the present disclosure may be combined, modified, and altered in various embodiments based on different viewpoints and applications, without departing from the idea of the present disclosure.

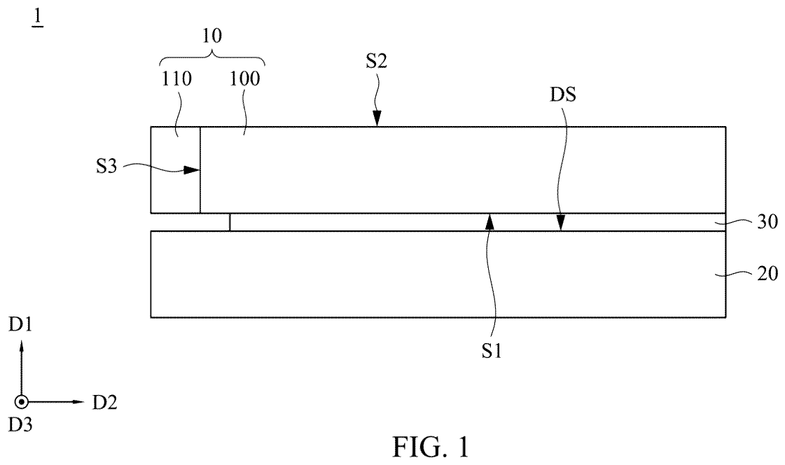

FIG. 1 is a schematic cross-sectional view of a reflective display device according to at least one embodiment of the disclosure. The reflective display device 1 includes a reflective display panel 20 and a light module 10. The reflective display panel 20 has a display surface DS, where the light module 10 is disposed on the display surface DS of the reflective display panel 20 and includes a light guide plate 100 and a light source 110. The light guide plate 100 has an inner light emitting surface S1, an outer light emitting surface S2, and a light incident surface S3, where the inner light emitting surface S1 faces the display surface DS and is opposite to the outer light emitting surface S2 along a first direction D1. The light incident surface S3 connects the inner light emitting surface S1 and outer light emitting surface S2, where the light source 110 is disposed on the light incident surface S3. The embodiment of the present disclosure is based on a reflective display device, but is not limited to this scope. In another embodiment of the present disclosure (not shown), the light module 10 is disposed below the other surface (non-display surface) of the display panel opposite to the display surface DS, where the display device is a non-reflective display device.

I As shown in FIG. 1, the reflective display device 1 further includes a connecting layer 30 disposed between the light module 10 and the reflective display panel 20 for connecting the light module 10 and the reflective display panel 20. In some embodiments, the material of the connecting layer 30 may be optical clear adhesive (OCA), optical clear resin (OCR), and/or other suitable materials. In some embodiments, the reflective display panel 20 may be an electrophoretic display panel or an electrowetting display panel.

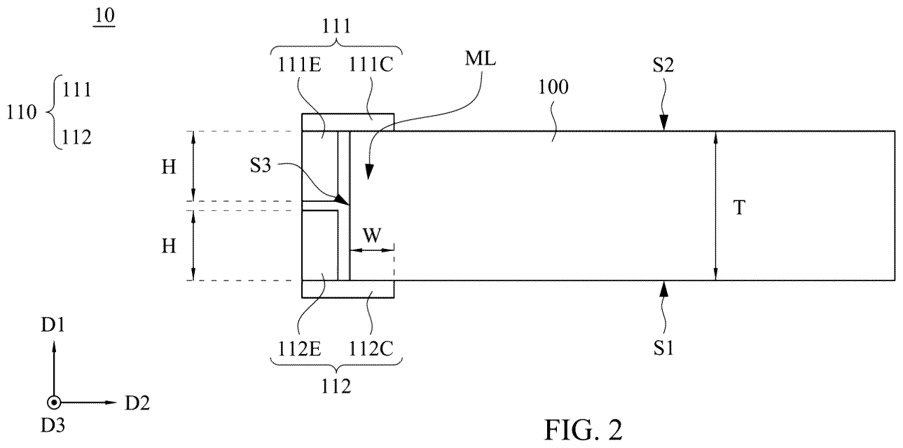

FIG. 2 is a schematic cross-sectional view of a light module according to at least one embodiment of the disclosure. Referring to FIG. 2, the light module 10 includes the light guide plate 100 and the light source 110, where the light source 110 includes a first light source 111 and a second light source 112. The first light source 111 is disposed on the light incident surface S3 and is located between the inner light emitting surface S1 and the outer light emitting surface S2 along the first direction D1, where the first light source 111 emits light of a first color temperature. The second light source 112 is disposed on the light incident surface S3 and is located between the first light source 111 and the outer light emitting surface S1 along the first direction D1, where the second light source 112 emits light of a second color temperature, and a difference between the first color temperature and the second color temperature is greater than 2000K.

By the abovementioned arrangement of the first light source 111 and the second light source 112 that emit light of different color temperatures, light of a suitable color temperature can be emitted to maintain or improve the image quality of the reflective display device 1. In addition, since the first light source 111 includes light emitting elements 111E with approximately the same color temperature, and the second light source 112 includes light emitting elements 112E with approximately the same color temperature, compared to the same light source including light emitting elements of different color temperatures, the pitch of the light emitting elements and the width of the light mixing area can be reduced, thereby meeting the demand for narrow-bezel products.

In some embodiments, the light emitted by the first light source 111 is one of cold light with a color temperature greater than or equal to 5300K and warm light with a color temperature less than or equal to 3300K. The light emitted by the second light source 112 is another of cold light with a color temperature greater than or equal to 5300K and warm light with a color temperature less than or equal to 3300K. For example, the light emitted by the first light source 111 may be cool light with a color temperature of 6500K and the light emitted by the second light source 112 may be warm light with a color temperature of 2600K.

Referring to FIG. 2, the first light source 111 includes a circuit substrate 111C and light emitting elements 111E disposed on the circuit substrate 111C, and the second light source 112 includes a circuit substrate 112C and light emitting elements 112E disposed on the circuit substrate 112C. The circuit substrate 111C of the first light source 111 is attached to the outer light emitting surface S2, and the circuit substrate 112C of the second light source 112 is attached to the inner light emitting surface S1. By the aforementioned design, the circuit substrate 112C attached to the inner light emitting surface S1 can replace the original black tape used to shield the light leakage.

In some embodiments, the first light source 111 and the second light source 112 may be light bars, respectively. In some embodiments, the circuit substrates 111C, 112C may be flexible circuit boards. In some embodiments, the surfaces of the circuit substrates 111C, 112C attached to the outer light emitting surface S2 and the inner light emitting surface S1 may include a material with high reflectivity, such as titanium dioxide or white ink. In some embodiments, the surfaces of the circuit substrates 111C, 112C opposite to the outer light emitting surface S2 and the inner light emitting surface S1 may include a material with high absorptivity, such as black ink. In another embodiment, the first light source 111 and the second light source 112 are arranged up and down on the same circuit substrate (not shown), and the light sources are fixed to the side of the light guide plate using fixing component. The above-mentioned fixing component is, for example, a tape or a casing.

As shown in FIG. 2, the light guide plate 100 has a thickness T in the first direction D1, and each of the light emitting elements 111E, 112E has a height H in the first direction D1. The height H of each light emitting element 111E, 112E is not greater than half of the thickness T of the light guide plate 100. In addition, the light guide plate 100 extends from the light incident surface S3 along a second direction D2 perpendicular to the first direction D1, and includes a light mixing area ML. The light mixing area ML having a width W in the second direction D2, so as to allow the light emitted from the first light source 111 and the second light source 112 to be mixed homogeneously in the light mixing area ML and then enter the display area.

In some embodiments, the light emitting elements 111E, 112E may be light emitting diodes (LEDs), for example, sub-millimeter light emitting diodes (mini LEDs). The sub-millimeter LEDs can be divided into two types: one including a package and the other not including a package. The height of the sub-millimeter LED including the package may be less than or equal to 0.8 mm, while the height of the sub-millimeter LED not including the package may be less than or equal to 0.1 mm. In some embodiments, the height H of each light emitting element 111E, 112E is not greater than 0.8 mm. In some embodiments, the light emitting elements 111E, 112E may be disposed on the circuit substrates 111C, 112C using wire bonding or flip-chip methods.

Since the first light source 111 and the second light source 112 of the light module 10 of at least one embodiment of the present disclosure are arranged along the first direction D1, that is, along the direction of the thickness T of the light guide plate 100, sub-millimeter light emitting diodes used as the light emitting elements 111E and 112E can use a light guide plate with a normal thickness or a thinner thickness. There is no need to use a thicker light guide plate due to the arrangement. Therefore, the lightness and thinness of the reflective display device can be maintained or improved.

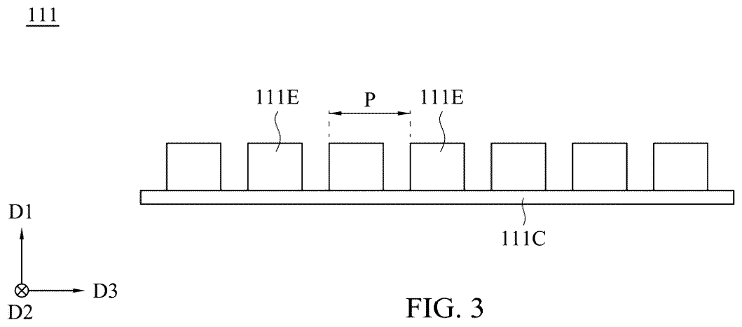

FIG. 3 is a schematic view of a light source according to at least one embodiment of the disclosure. Referring to FIG. 3, taking the first light source 111 as an example, each of the light emitting elements 111E is arranged on the circuit substrate 111C at a pitch P along the third direction D3 perpendicular to the first direction D1 and the second direction D2. The ratio of the width W of the light mixing area ML to the pitch P of the light emitting elements 111E is less than 1. In addition, the pitch of the light emitting elements 112E of the second light source 112 also conforms to the aforementioned relationship.

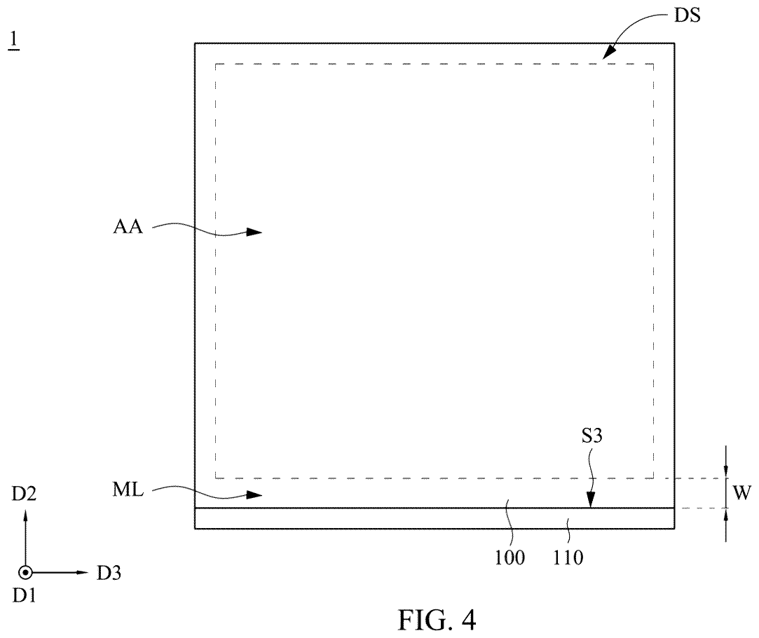

FIG. 4 is a schematic top view of a reflective display device according to at least one embodiment of the disclosure. Referring to FIG. 4, the display surface DS has a display area AA, and the light guide plate 100 includes the light mixing area ML located between the light incident surface S3 and the display area AA. The light mixing area ML has the width W in the second direction D2 perpendicular to the first direction D1. As shown in FIGS. 3 and 4, each light emitting element 111E, 112E is arranged on the circuit substrate 111C, 112C with the pitch P along the third direction D3 perpendicular to the first direction D1 and the second direction D2. The ratio of the width W of the mixing area ML to the pitch P of light emitting elements 111E, 112E is less than 1.

The following table shows experimental data for the comparative example and the embodiment of FIG. 2. In detail, the structure of the embodiment of FIG. 2 is that the first light source 111 includes the light emitting elements 111E emitting light of the first color temperature arranged on the circuit substrate 111C along the third direction D3, and the second light source 112 includes the light emitting elements 112E emitting light of the second color temperature arranged on the circuit substrate 112C along the third direction D3. The first light source 111 and the second light source 112 are located on the light incident surface S3 of the light guide plate 100 in the first direction D1, i.e., two single color temperature light bars emitting light of different color temperatures are arranged on the light incident surface of the light guide plate 100 in the thickness direction of the light guide plate 100 in sequence. The structure of the comparative example is that a light source including two kinds of light emitting elements that emit light of different color temperatures are staggered on the circuit substrate, and this light source is dispose on the light incident surface of the light guide plate, i.e., a dual-color-temperature light bar emitting light of different color temperatures is disposed on the light incident surface of the light guide plate.

| | Height | Pitch | Width of light | |
|---|---|---|---|---|
| | of LED, | of LEDs, | mixing area, | |
| | H(mm) | P(mm) | W(mm) | W/P |
| Comparative example | 0.4 | 10 | 10 | 1 |
| Embodiment | 0.2 | 5 | 3.5 | 0.7 |

As can be seen from the above table, the height of the light emitting element of the embodiment is half of the height of the light emitting element of the comparative example, so the same thickness of the light-guide plate can be used. In addition, the pitch of the light emitting elements of the embodiment is smaller than the pitch of the light emitting elements of the comparative example, and the width of the light mixing area of the embodiment is smaller than the width of the light mixing area of the comparative example. Therefore, the width of the bezel of the display device which used the embodiment can be reduced by 6.5 mm, or 65%, compared to the width of the bezel of the display device which used the comparative example.

Since the first light source 111 and the second light source 112 of the light module 10 of the least one embodiment of the present disclosure include the light emitting elements 111E that emit light of the first color temperature and the light emitting elements 112E that emit light of the second color temperature, sparse dots and dense dots (not shown) are provided on the light guide plate 100 corresponding to the light emitting positions and the intervals of the light emitting elements 111E and 112E to help light mixing and reduce the width W of the light mixing area ML. However, in the comparative example, since a light source includes two kinds of light emitting elements that emit light of different color temperatures and are arranged in a staggered manner. If sparse dots and dense dots are provided on the light guide plate corresponding to the light emitting positions and the intervals of one kind of light emitting elements. It will cause dense dots on the light guide plate corresponding to the light emitting positions of the other kind of light emitting elements, and sparse dots on the light guide plate at the intervals of the other kind of light emitting elements, which will result in the other kind of light emitting elements generating hot spots at its light output. Therefore, sparse dots and dense dots are not suitable for the comparative example, and a larger width of the light mixing area may be required.

In summary, the present disclosure is to maintain or improve the image quality of the reflective display device 1 by emitting light of a suitable color temperature by the arrangement of the first light source 111 and the second light source 112 of the light module 10 which emit light of different color temperatures. In addition, since the light emitting elements of the first light source 111 are with approximately the same color temperature and the light emitting elements of the second light source 112 are with approximately the same color temperature, compared to the same light source with light emitting elements of different color temperatures, the pitch of the light emitting elements and the width of the light mixing area can be reduced, thus achieving the demand for narrow-bezel products.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A light module, comprising:
a light guide plate, having an inner light emitting surface, an outer light emitting surface opposite to the inner light emitting surface along a first direction, and a light incident surface connecting the inner light emitting surface and the outer light emitting surface;
a first light source, disposed on the light incident surface and located between the inner light emitting surface and the outer light emitting surface along the first direction, and an emitted light of the first light source having a first color temperature; and
a second light source, disposed on the light incident surface and located between the first light source and the inner light emitting surface along the first direction, and an emitted light of the second light source having a second color temperature, wherein a difference between the first color temperature and the second color temperature is greater than 2000K.

2. The light module of claim 1, wherein the emitted light of the first light source is one of a cold light with a color temperature greater than or equal to 5300K and a warm light with a color temperature less than or equal to 3300K.

3. The light module of claim 2, wherein the emitted light of the second light source is the other of the cold light with the color temperature greater than or equal to 5300K and the warm light with the color temperature less than or equal to 3300K.

4. The light module of claim 1, wherein the first light source and the second light source respectively include a circuit substrate and a plurality of light emitting elements arranged on the circuit substrate, wherein the circuit substrate of the first light source is attached to the outer light emitting surface, and the circuit substrate of the second light source is attached to the inner light emitting surface.

5. The light module of claim 4, wherein the light guide plate has a thickness in the first direction, each of the light emitting elements has a height in the first direction, the height is not greater than half of the thickness.

6. The light module of claim 5, wherein the height is not greater than 0.8 mm.

7. The light module of claim 4, wherein the light guide plate extends from the light incident surface along a second direction perpendicular to the first direction and comprises a light mixing area having a width in the second direction, wherein each of the light emitting elements is arranged on the circuit substrate with a pitch along a third direction perpendicular to the first direction and the second direction, and a ratio of the width to the pitch is less than 1.

8. A display device, comprising:
a display panel, having a display surface;
a light module, disposed on the display surface and comprising:
a light guide plate, having an inner light emitting surface, an outer light emitting surface and a light incident surface, wherein the inner light emitting surface faces the display surface and is opposite to the outer light emitting surface along a first direction, and the light incident surface connects the inner light emitting surface and the outer light emitting surface;
a first light source, disposed on the light incident surface and located between the inner light emitting surface and the outer light emitting surface along the first direction, and an emitted light of the first light source having a first color temperature; and
a second light source, disposed on the light incident surface and located between the first light source and the inner light emitting surface along the first direction, and an emitted light of the second light source having a second color temperature, wherein a difference between the first color temperature and the second color temperature is greater than 2000K.

9. The display device of claim 8, wherein the emitted light of the first light source is one of a cold light with a color temperature greater than or equal to 5300K and a warm light with a color temperature less than or equal to 3300K.

10. The display device of claim 9, wherein the emitted light of the second light source is the other of the cold light with the color temperature greater than or equal to 5300K and the warm light with the color temperature less than or equal to 3300K.

11. The display device of claim 8, wherein the first light source and the second light source respectively include a circuit substrate and a plurality of light emitting elements arranged on the circuit substrate, wherein the circuit substrate of the first light source is attached to the outer light emitting surface, and the circuit substrate of the second light source is attached to the inner light emitting surface.

12. The display device of claim 11, wherein the light guide plate has a thickness in the first direction, each of the light emitting elements has a height in the first direction, the height is not greater than half of the thickness.

13. The display device of claim 12, wherein the height is not greater than 0.8 mm.

14. The display device of claim 11, wherein the display surface has a display area, and the light guide plate comprises a light mixing area between the light incident surface and the display area, the light mixing area has a width in a second direction perpendicular to the first direction, wherein each of the light emitting elements is arranged on the circuit substrate with a pitch along a third direction perpendicular to the first direction and the second direction, and a ratio of the width to the pitch is less than 1.
